(19) United States
(12) Patent Application Publication
(10) Pub. No.: US 2019/0280908 A1
(43) Pub. Date: Sep. 12, 2019

(54) NETWORK DEVICE AND A BASEBAND UNIT FOR A TELECOMMUNICATION SYSTEM

(71) Applicant: HUAWEI TECHNOLOGIES CO., LTD., Shenzhen (CN)

(72) Inventors: Tao CAI, Kista (SE); Kari Juhani LEPPANEN, Kista (SE); Alister Graham BURR, Kista (SE); Rui LEI, Kista (SE)

(21) Appl. No.: 16/420,279

(22) Filed: May 23, 2019

Related U.S. Application Data
(63) Continuation of application No. PCT/EP2016/078571, filed on Nov. 23, 2016.

(51) Int. Cl. H04L 25/49; H04B 17/309; H04B 17/14; H04B 17/10; H04L 25/02

(52) U.S. Cl. CPC H04L 25/4927; H04B 17/309; H04L 25/0262; H04B 17/104; H04B 17/14

(57) ABSTRACT

A baseband unit may be arranged to serve a plurality of remotely located network devices. Network devices are connected to the baseband unit using a fronthaul network. The disclosed network device separates signals belonging to different users before quantizing and transmits the quantized separated signals to the baseband unit. The baseband unit may monitor the quality of the link of the fronthaul network and determine the number of bits used for quantizing.

### CROSS REFERENCE TO RELATED APPLICATIONS

This application is a continuation of International Application No. PCT/EP2016/078571, filed on Nov. 23, 2016, the disclosure of which is hereby incorporated by reference in its entirety.

### FIELD

The present application relates to the field of telecommunication, and more particularly to a network device and a base band unit.

### BACKGROUND

A base station is a networking device that allows wireless devices to connect to a wired network or another wireless network. Base stations are used, for example, in mobile communication networks and wireless local area networks. Conventionally base stations included a radio interface and an interface to a wired network. In the conventional arrangement a base station comprises an antenna through which it communicates with a user device. The base station processes all information communicated with the user device.

Wireless data communication technologies have evolved from conventional base stations to solutions where a plurality of antennas are used for communication between the radio interface of a base station and a user device. In one base station there may be several radio interfaces comprising a plurality of antennas that all communicate with one user device that also comprises plurality of antennas. In such arrangements the several radio interfaces are typically implemented as a remote radio units that are connected to one baseband processing unit. Between the remote radio units and baseband unit is a network connection that is typically called “fronthaul”. Typically the fronthaul connection is a wired connection with high bandwidth.

One example of such arrangement is Cloud Radio Access Network (C-RAN) technology. Instead of full base station functionality being provided at each antenna site, the antenna may be equipped only with a Remote Radio Unit (RRU). The remote radio unit contains only radio frequency (RF) processing equipment and an analogue to digital converter (ADC). The RF processing equipment converts the radio signal to complex baseband containing in phase and quadrature modulating signals. The ADC quantizes the signals to convert them to digital form. The digital form is then transmitted over the fronthaul network to a central baseband unit (BBU) which performs all processing of the complex baseband signals (modulation/demodulation, coding/decoding, higher layer protocols, etc.) from antenna sites covering a wide area.

This may provide economies of scale in performing the processing, and reduces the energy requirements at the antenna sites, potentially saving energy. It also allows joint processing of signals from multiple antenna sites, which has potential to greatly improve the performance of the radio access network. The arrangement operates in both up and down-link. In both cases the fronthaul network carried quantized signals rather than user data.

The load on the fronthaul network of a C-RAN is very large in comparison for what would be required for the more conventional backhaul network which is used in current radio access networks to connect base stations to the core network. In principle each RRU requires a data rate proportional to the bandwidth of the signals and the number of antennas, regardless of how many users are being served. The load may easily be in the tens of Gbps per RRU, and is typically many times the total data rate of the users being served.

### SUMMARY

In the following description a network device and a baseband unit are disclosed. Furthermore a system using at least one network device and a baseband unit is disclosed. In addition to the network device, baseband unit and system a method for operating the network device, baseband unit and system is disclosed.

In the first aspect a network device for wireless communication is disclosed. The network device comprises a first transceiver conFigured to receive a signal from an at least one user equipment. The network device further comprises a processor conFigured to separate signals belonging to each user equipment from the received signal and quantize said separated signals. The network device further comprises a second transceiver conFigured to transmit said quantized signals.

The network device according to the first aspect is conFigured to separate the signals belonging to different user equipment thus taking multiple user situation into account. This facilitates the quantization to be performed in per user or user equipment basis. This is beneficial because quantization is a non-linear process and when applied to mixed signals it generates additional spurious components which interfere with the intended signals. This effect can be reduced by increasing the word length used to represent the quantized samples; however when the quantization is performed on already separated signals the generation of spurious components is greatly reduced. The number of used quantization bits can then also be reduced. This reduces the data transfer requirement of the fronthaul network between the network device and a baseband unit. Furthermore, in the approach described above results in a fronthaul load that is much more closely related to the total user data rate and thus improves efficiency.

In the first implementation of the first aspect said processor is further conFigured to receive a determined number of quantization bits and control quantization of said separated signals in accordance with said received number of quantization bits determined based on at least one of the following: an access link quality between user equipment and said network device and a data transfer rate between said network device and a baseband unit. This is particularly beneficial because the number of used quantization bits can be dynamically changed based on the access link quality. The baseband unit receives the quantized signals and can determine if the quantization level is adequate. Thus, it is not necessary to always use higher number of bits and the data transfer need is reduced. The access link quality mentioned above may be determined using a channel estimator and is typically based on signal-to-noise.

In the second implementation of the first aspect said network device further comprises a beamformer conFigured to separate N signals received by M antennas into K user equipment signals from the received signal by said first transceiver. It is beneficial to use the beamformer at this stage when the signal is received from a plurality of user equipment using a plurality of antennas and beamformer is a common component in systems involving a plurality of antennas.

In the third implementation of the first aspect said network device said processor is further conFigured to separate sub-channels of said received signal by said first transceiver before separating signals belonging to each user equipment. This facilitates using a frequency division multiplexing approach, for example, orthogonal frequency-division multiplexing (OFDM).

In the fourth implementation of the first aspect said network device further comprises a channel estimator conFigured to estimate channel properties between said at least one user equipment and said network device before separating signals belonging to each user equipment. It is beneficial to know channel properties when the signals are separated into signals belonging to each user equipment. When the channel properties are known with sufficient accuracy the signal separation can done with better accuracy.

In a second aspect a baseband unit is disclosed. The baseband unit comprises a transceiver conFigured to receive signals from one or more network devices, wherein each of received signals comprises a quantized separated signal belonging to each user equipment and a processor conFigured to combine signals received from at least two network devices and belonging to same user equipment.

Using a baseband unit according to the second aspect is beneficial because it facilitates receiving signals that have been separated and quantized in a network device such as the network device described above. Receiving separated signals provides possibility to reduce the network load between the baseband unit and the network device because of reduced need of quantization bits. Furthermore, when the signals are separated the data transfer need between a baseband unit and one or more network devices is proportional to data transfer needs of the users.

In the first implementation of the second aspect said transceiver is conFigured to determine the number of quantization bits and transmit the determined number of quantization bits to one or more network devices. This is beneficial so that the network device can choose on appropriate number of quantization bits when quantizing separated signals.

In the second implementation of the second aspect said processor is further conFigured to receive the number of quantization bits from an external device and transmit the determined number of quantization bits to one or more network devices. This beneficial that in one implementation the number of bits can be determined in the baseband unit but in other implementations it is also possible to determine the number of bits in an external device. This increases flexibility of the system designs.

In third aspect a system is disclosed. The system comprises a plurality of network devices, wherein each of network devices further comprise a first transceiver conFigured to communicate with a number of user equipment. The network devices further comprise a processor conFigured to separate signals belonging to a different user equipment from a received signal by said first transceiver and quantize said separated signals and a second transceiver conFigured to transmit said quantized signals. The system further comprises a baseband unit and a network connection conFigured to transfer data between said plurality of network devices and said baseband unit.

The system as disclosed above is beneficial because of the reduced need of data transfer capacity between network devices and the baseband unit. This provides cost savings as the capacity between network devices and the baseband unit can be designed more accurately and cost efficiently. Furthermore, as the need for data transfer capacity is reduced it is possible to use similar network connection for a larger number of network devices. The network devices may be implemented as a remote radio unit or form a part of a remote radio unit.

In a fourth aspect a method is disclosed. The method for transmitting data from a network device to a baseband unit comprises receiving a radio signal from an at least one user equipment; separating signals belonging to each user equipment from said received radio signal; quantizing said separated signals; and transmitting said quantized signals to a baseband unit.

The method according to the fourth aspect separates the signals belonging to different user equipment thus taking multiple user situation into account. This facilitates the quantization to be performed in per user or user equipment basis. This is beneficial because quantization is a non-linear process and when applied to mixed signals it generates additional spurious components which interfere with the intended signals. This effect can be reduced by increasing the word length used to represent the quantized samples; however when the quantization is performed on already separated signals the generation of spurious components is greatly reduced. The number of used quantization bits can then also be reduced. This reduces the data transfer requirement of the fronthaul network between the network device and a baseband unit. Furthermore, in the approach described above results in a fronthaul load that is much more closely related to the total user data rate and thus improves efficiency.

In the first implementation of the fourth aspect said method further comprises collecting information of at least one of the following: an access link quality between said at least one user equipment and network devices; and data transfer rate between said network devices and said baseband unit; determining at said baseband unit the required number of quantization bits based on said collected information, and transmitting said determined number of quantization bits to at least one network device.

This is particularly beneficial because the number of used quantization bits can be dynamically changed based on the access link quality or the data transfer rate. The baseband unit receives the quantized signals and can determine if the quantization level is adequate. Thus, it is not necessary to always use higher number of bits and the data transfer need is reduced.

In the second implementation of the fourth aspect the method further comprises separating sub-channels of said received signal radio signal and separating signals belonging to each user equipment from said separated sub-channels. This facilitates using a frequency division multiplexing approach, for example, orthogonal frequency-division multiplexing (OFDM).

In the third implementation of the fourth aspect the method further comprises separating signals belonging to each user equipment using beamforming. It is beneficial to use beamforming at this stage when the signal is received from a plurality of user equipment using a plurality of antennas and beamforming is a technology component in systems involving a plurality of antennas.

In the fourth implementation of the fourth aspect the method further comprises receiving at said network device the number of quantization bits and controlling quantization in accordance with said received number of quantization bits. It is beneficial for the network device to receive the number of quantization bits from a baseband unit as it provides a channel for feedback for the determinations made in the baseband unit. The baseband unit, based on the estimation of “access link quality” and/or the measurement of ratio of “fronthaul link load”/“fronthaul link capacity”, decides an optimal number of quantization bits. This optimal number of quantization bits is to avoid overflow on the fronthaul link where the fronthaul link load exceeding the fronthaul link capacity, and/or to achieve an optimal overall reception result of all UE signals at baseband unit.

In the fifth implementation of the fourth aspect the method further comprises receiving quantized signals from at least two network devices, wherein each of received quantized signals comprises a quantized separated signal origination from one user equipment and combining signals received from at least two of network devices belonging to the same user equipment. It is beneficial to allow use of a plurality of network devices to communicate with a single user equipment. The received signals can then be combined in the baseband unit in order to form a complete signal belonging to a user equipment to achieve e.g. diversity combining gain.

The network device, baseband unit, system and method disclosed above provide an efficient way for organizing a base station particularly when a plurality of network devices are connected to a single baseband unit.

### DESCRIPTION OF THE DRAWINGS

The present description will be better understood from the following detailed description read in light of the accompanying drawings, wherein:

FIG. 1a illustrates a schematic representation of an example of a network device;

FIG. 1b illustrates a schematic representation of an example of a network device;

FIG. 1c illustrates a schematic representation of an example of a baseband unit;

FIG. 1d illustrates a schematic representation of an example of a baseband system;

FIG. 2 illustrates a schematic representation of an example with tow network devices;

FIG. 3 illustrates a flow chart of a method;

FIG. 4 illustrates a flow chart of a method;

FIG. 5 is an illustration of a simulation results;

FIG. 6 is an illustration of a simulation results;

FIG. 7 is an illustration of a simulation results;

### DETAILED DESCRIPTION

The following detailed description in connection with the appended Figures is intended as a description of the exemplary embodiments and is not intended to represent the only forms in which the embodiment may be constructed or utilized. However, the same or equivalent functions and structures may be accomplished by different embodiments.

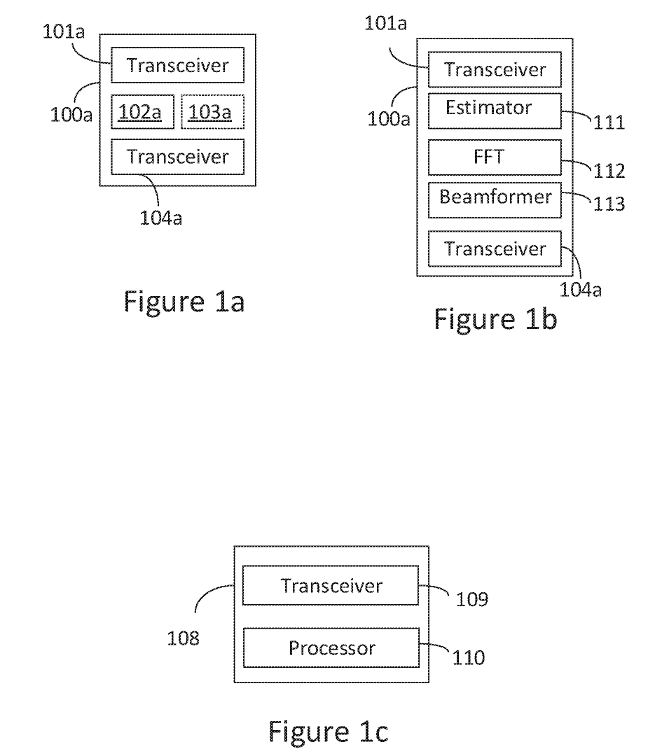

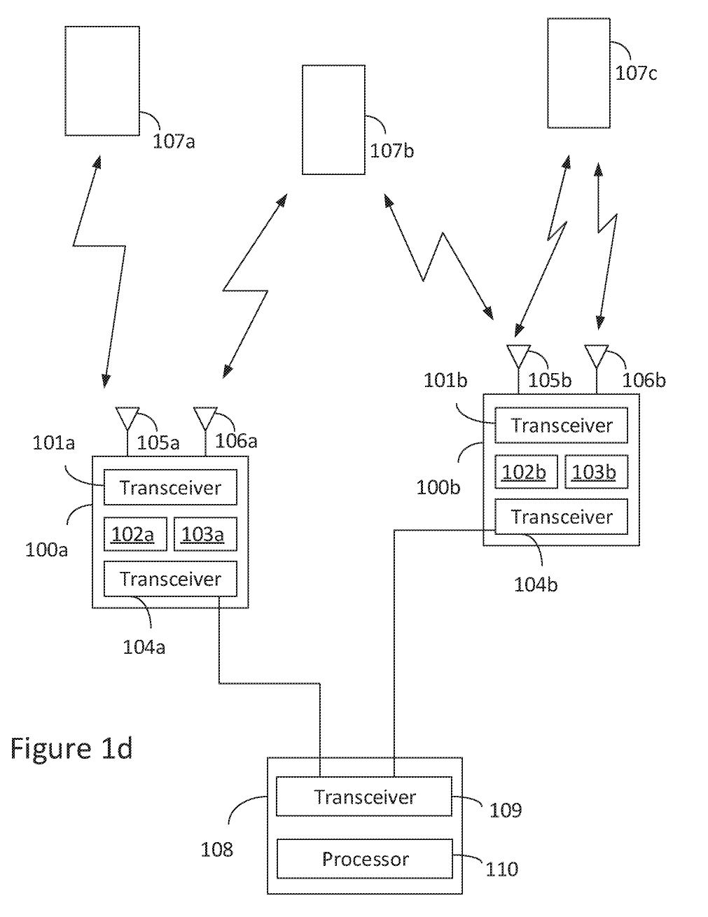

In an aspect the network device 100a comprises a first transceiver 101a conFigured to receive a signal from an at least one user equipment. FIG. 1a shows an example of such a network device. The network device further comprises a processor 102a conFigured to separate signals belonging to each user equipment from the received signal and quantize the separated signals. The network 100 element further comprises a second transceiver 104a conFigured to transmit the quantized signals. The network device 100a optionally comprises a memory 103a that is used to support the processor.

The network device according to the first aspect is conFigured to separate the signals belonging to different user equipment thus taking multiple user situation into account. This facilitates the quantization to be performed in per user or user equipment basis. This is beneficial because quantization is a non-linear process and when applied to mixed signals it generates additional spurious components which interfere with the intended signals. When the quantization is done to already separated signals the size of the quantized samples is reduced which is beneficial because of the non-linear nature. Furthermore, as the additional spurious components and interfering signals are reduced the number of used quantization bits can also be reduced. This reduces the date transfer requirement of the fronthaul network between the network device and a baseband unit. Furthermore, in the approach described above results in a fronthaul load that is much more close related to the total user data rate and thus improves efficiency.

The network device discussed here with referral to the Figures can be used as a remote radio unit (RRU), or as a part of forming the remote radio unit or similar, of a base station in a cloud radio access network (C-RAN). Typically each base station comprises one baseband unit and a plurality of remote radio units. Even if in the following description remote radio units are used as an example also other devices sharing the same principles may be implemented using the principles explained in the detailed description. It is understood that the network device, or the remote radio unit, may be incorporated also additional components that do not relate with the functionality disclosed in the following description.

At the network device, following RF processing a beam-former or other appropriate spatial filter is applied by the processor 102a to separate to some degree signals from different users, which are either located in different directions or received via radio channels with different amplitudes and phases, which can be exploited to assist in the separation. The corresponding signals are then quantized to only that precision which is required according to the modulation being used by the user and on the sub-channels in question. The separation means that each signal quantized contains mainly the signal from one user, with component signals from other users being reduced to low levels. This reduces the intermodulation effect due to quantization of a mixture of signals.

The bits representing the quantized signals are then transmitted over the fronthaul network to the BBU. At the BBU signals corresponding to the same user via different network devices are combined in relative proportions according to the strength and accuracy of the signals. The remaining demodulation, decoding and other processing is performed at the BBU on the combined signals. Because of the reduction or elimination of intermodulation, the approach disclosed has the potential to eliminate the error floor due to quantization.

In an embodiment the processor 102a is conFigured to receive a determined number of quantization bits and control quantization of said separated signals in accordance with said received number of quantization bits determined based on at least one of the following: an access link quality between user equipment and said network device and a data transfer rate between said network device and a baseband unit. This is particularly beneficial because the number of used quantization bits can be dynamically changed based on the access link quality. The baseband unit receives the quantized signals and can determine if the quantization level is adequate. Thus, it is not necessary to always use higher number of bits and the data transfer need is reduced. The access link quality mentioned above may be determined using a channel estimator and is typically based on signal-to-noise.

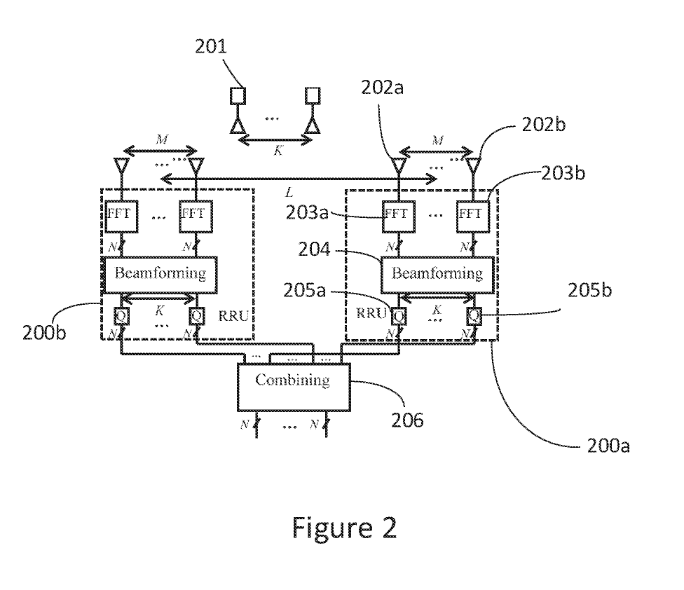

In embodiment two network devices 200a, 200b are used. FIG. 2 shows an example of an embodiment with two network devices. In the following the network device 200a is explained in detail. Network devices 200a and 200b are similar but need not to be exactly the same. Network devices 200a, 200b are conFigured to communicate with user equipment, such as a user device 201. For example, each network device may have configuration that is related to the particular location. In the embodiment the network device 201a further comprises a beamformer 204 conFigured to separate N signals received by M antennas 202a, 202b into K user equipment signals from the received signal by the first transceiver. It is beneficial to use the beamformer at this stage when the signal is received from a plurality of user equipment using a plurality of antennas and the beamformer is a common component in systems involving a plurality of antennas.

The purpose of the arrangement is to reduce the uplink fronthaul load in a C-RAN system using multiple antenna network devices or in any other similar system. In conventional approaches the fronthaul load from a given network device is proportional to the total signal bandwidth and the number of antennas rather than being related to the actual data rate of terminals received at the network device, and hence is highly inefficient in many cases, especially when only few terminals are served and when they operate at low data rates.

In the embodiment exemplified in FIG. 2 the network device the processor is further conFigured to separate sub-channels of the received signal by the first transceiver before separating signals belonging to each user equipment. This facilitates using a frequency division multiplexing approach, for example, orthogonal frequency-division multiplexing (OFDM). This separation is done in the embodiment exemplified in FIG. 2 by using a particular Fast Fourier Transformers 203a, 203b. These transformers 203a, 203b may be special purpose components performing only the transformation or they may be implemented with a processor and memory, such as the processor 102 and memory 103 in FIG. 1a.

In an embodiment the network device further comprises a channel estimator conFigured to estimate channel properties between the at least one user equipment and the network device before separating signals belonging to each user equipment. An example of such embodiment is shown in FIG. 1b. It is beneficial to know channel properties when the signals are separated into signals belonging to each user equipment. When the channel properties are known with sufficient accuracy the signal separation can done with better accuracy.

Another embodiment comprises transceivers 101a and 104d as the embodiment exemplified in FIG. 1a. An example of such embodiment is shown in FIG. 1b. The embodiment of FIG. 1b further comprises a channel estimator 111, a fast Fourier transformer 112 and a beamformer 113. In the embodiment the fast Fourier transformer 112 and the beamformer 113 are special purpose components conFigured to perform their particular functionality instead of using a general purpose processor and memory as in FIG. 1a. The channel estimator 111 shown in FIG. 1b is conFigured to provide information for the beamformer 113. In the FIG. 1b it is located between the transceiver 101a and the fast Fourier transformer 112 but it can be located also otherwise provided that it is able to provide information for the beamformer 111. Thus, even if the channel estimator is not shown in FIG. 2 it can be added to the without problems to the embodiment by following the principles described above. Furthermore, it should be noted that the fast Fourier transformer 112 is an optional component and required when a multiplexing scheme requiring the transformation is used.

Referring again to the exemplary embodiment illustrated in FIG. 2, applied to the uplink of a typical radio access system, in this example using OFDM transmission with N subcarriers as in LTE (Long Term Evolution) along with associated modulation and coding, and other aspects of the LTE air-interface, but not limited to this scheme. We assume that a set of user terminals transmitting independent data streams over a total of K antennas are served by L network devices, each being equipped with M antennas. (The K antennas may consist of a single antenna attached to each of K terminals, or of fewer than K terminals, at least some of which are equipped with more than one antenna, used for spatial multiplexing in some form, such that a total of K antennas transmit K independent data streams.) In this example we assume that M≥K.

At each antenna down-conversion is performed to complex baseband, followed by a length N FFT operation, along with cyclic prefix removal as in a conventional OFDM receiver, returning the complex signals for each subcarrier. Provided the cyclic prefix is long enough, the nth subcarrier can be treated as a flat fading channel. The joint channel between the K terminal antennas and the M receive antennas on the l^{th} network device for the n^{th} subcarrier may be represented by an M×K matrix H_{n,l}. At this network device beamforming may be applied to separate the signals from the K user terminal antennas. In the exemplary embodiment this beamforming takes the form of a zero-forcing (ZF) beamformer, which provides outputs for the estimated signals from each terminal antenna in which the interference from other antennas is nulled. Using the matrix notation the length M vector r_{n,l} of received signals on the M receive antennas in the n^{th} subcarrier on the l^{th} network device can be written:

r_{n,l}=H_{n,l}sₙ+n_{n,l}

Where s_{n,l} denotes the length K vector of signals from the user antennas in the n^{th} subcarrier, and n_{n,l} the length M vector of noise signals on the receive antennas in the n^{th} subcarrier on the l^{th} network device. The ZF beamformer computes a length K vector of estimates of the transmitted signals using:

ŝ_{n,l}=G_{n,l}r_{n,l} with G_{n,l}=(H_{n,l}^{H}H_{n,l})⁻¹H_{n,l}^{H}

Where H_{n,l}^{H} denotes the Hermitian (transpose conjugate) of the channel matrix, and (H_{n,l}^{H}H_{n,l})⁻¹ denotes matrix inverse. This estimate nulls interference to each user signal estimate from the other signals, but may enhance the effect of noise. In an alternative embodiment the beamformer might be based on a minimum mean square error (MMSE) estimator, which would maximize the signal to noise-plus-interference ratio.

These estimates are then quantized, as denoted by the blocks marked Q in FIG. 2: the minimum number of bits in the quantization is clearly the number of bits per symbol of the modulation scheme, which is the logarithm to base 2 of the number of constellation points. However typically a certain number of “extra bits” of precision in the quantization are used: the more extra bits, the better the end-to-end performance of the system, in terms of the end-to-end BER as a function of the bit energy to noise density ratio (E_{b}/N₀) of the access links. Of course increasing the number of “extra bits” also increases the fronthaul load: hence the arrangement allows a trade-off between fronthaul load and required access link E_{b}/N₀.

The quantized signals are then transmitted over the fronthaul link to the BBU using some digital transmission technology: in this example embodiment we assume these links are error-free. At the BBU the signal estimates are reconstructed and then combined using maximum ratio combining (MRC) taking into account the noise enhancement, in the sense that the overall signal to noise ratio of the combined signal is maximized. The combiner computes a combined estimate:

$${\hat{s}}_{n} = {\sum }_{i = 1}^{L} {A}_{i} {\hat{s}}_{n , l} with {A}_{i} = diag ( {diag ( {G}_{n , i} {G}_{n , i}^{H} )}^{- 1} )$$

Where the function diag(.) applied to a matrix returns a vector of the elements on its main diagonal, and when applied to a vector returns a square matrix with that vector on its main diagonal. The resulting combined estimate vector for the n^{th} subcarrier can then be passed to a demodulator, decoder, and all remaining physical layer functions, which are located at the BBU.

In an aspect the baseband unit 108 comprises a transceiver 109 conFigured to receive signals from one or more radio units, wherein each of received signals comprises a quantized separated signal belonging to each user equipment and a processor 109 conFigured to combine signals received from at least two remote radio units and belonging to same user equipment. Such an aspect is exemplified in FIG. 1c.

Using a baseband unit according to the second aspect is beneficial because it facilitates receiving signals that have been separated in a remote radio unit such as the network device described above. Receiving separated signals provides possibility to reduce the network load between the baseband unit and the remote radio unit because of reduced need of quantization bits. Furthermore, when the signals are separated the data transfer need between a baseband unit and one or more remote radio units is proportional to data transfer needs of the users.

In an embodiment the transceiver is conFigured determine the number of quantization bits and transmit the determined number of quantization bits to one or more network devices. This is beneficial so that the remote radio unit can choose on appropriate number of quantization bits when quantizing separated signals.

In another embodiment the processor is further conFigured to receive the number of quantization bits from an external device and transmit the determined number of quantization bits to one or more network devices. This beneficial that in one implementation the number of bits can be determined in the baseband unit but in other implementations it is also possible to determine the number of bits in an external device. This increases flexibility of the system designs.

In an aspect the system comprises a plurality of network devices 100a, 100b, wherein each of network devices further comprise a first transceiver 101a, 101b conFigured to communicate with a number of user equipment 107a-107c. The network devices 100a, 100b further comprise a processor 102a, 102b conFigured to separate signals belonging to a different user equipment 107a-107c from a received signal by the first transceiver 101a, 101b and quantize the separated signals and a second transceiver 104a, 104b conFigured to transmit the quantized signals. The system further comprises a baseband unit 108 and a network connection conFigured to transfer data between the plurality of remote radio units 101a, 101b and the baseband unit 108. Such a system is exemplified in FIG. 1d. The baseband unit further comprises a transceiver 109 and a processor 110. The baseband unit may be similar to the baseband unit of FIG. 1c and the network devices may be similar to the network devices of FIG. 1a or 1b. The system of FIG. 1d comprising at least one network device 100a, 100b and a baseband unit 108 may be used as a base station in a mobile communications network.

The system as disclosed above is beneficial because of the reduced need of data transfer capacity between network devices and the baseband unit. This provides cost savings as the capacity between network devices and the baseband unit can be designed more accurately and cost efficiently. Furthermore, as the need for data transfer capacity is reduced it is possible to use similar network connection for a larger number of remote radio units.

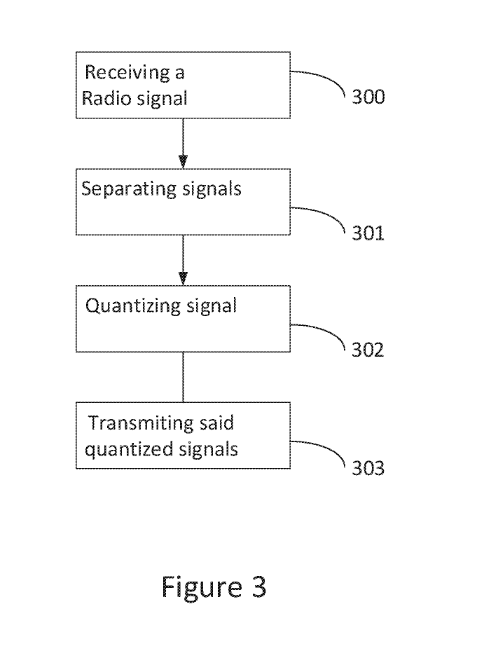

In another aspect a method for transmitting is disclose. An example of such method is shown in FIG. 3. The method for transmitting data from a remote radio unit to a baseband unit comprises receiving, step 300, a radio signal from an at least one user equipment; separating, step 301 signals belonging to each user equipment from the received radio signal; quantizing, step 303 the separated signals; and transmitting, step 304, the quantized signals to a baseband unit. The method may be implemented in a network device similar to the network devices described above.

The method separates the signals belonging to different user equipment thus taking multiple user situations into account. This facilitates the quantization to be performed in per user or user equipment basis. This is beneficial because quantization is a non-linear process and when applied to mixed signals it generates additional spurious components which interfere with the intended signals. When the quantization is done to already separated signals the size of the quantized samples is reduced which is beneficial because of the non-linear nature. Furthermore, as the additional spurious components and interfering signals are reduced the number of used quantization bits can also be reduced. This reduces the date transfer requirement of the fronthaul network between the network device and a baseband unit. Furthermore, in the approach described above results in a fronthaul load that is much more close related to the total user data rate and thus improves efficiency.

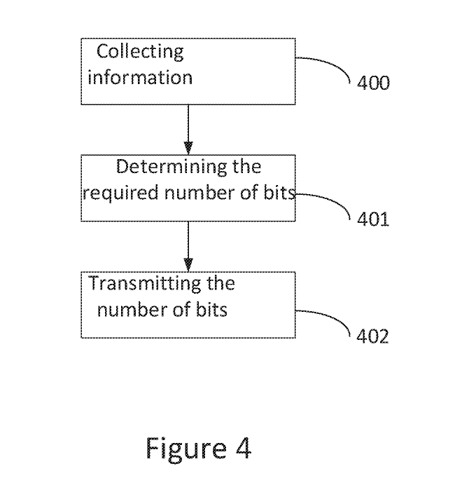

In an embodiment the method further comprises collecting, step 400, information with regard the access link quality and/or data transfer rate between remote radio units and baseband unit; determining, step 401, at the baseband unit the required number of quantization bits based on the collected information, and transmitting, step 403, the determined number of quantization bits to at least one remote radio unit. The method of FIG. 4 may be implemented in a baseband unit similar to a baseband unit described above.

This is particularly beneficial because the number of used quantization bits can be dynamically changed based on the access link quality or the data transfer rate. The baseband unit receives the quantized signals and can determine if the quantization level is adequate. Thus, it is not necessary to always use higher number of bits and the data transfer need is reduced.

In an embodiment the method further comprises separating sub-channels of the received signal radio signal and separating signals belonging to each user equipment from the separated sub-channels. This facilitates using a frequency division multiplexing approach, for example, orthogonal frequency-division multiplexing (OFDM).

In an embodiment the method further comprises separating signals belonging to each user equipment using beamforming. It is beneficial to use beamforming at this stage when the signal is received from a plurality of user equipment using a plurality of antennas and beamforming is a technology component in systems involving a plurality of antennas

In an embodiment the method further comprises receiving at the remote radio unit the number of quantization bits and controlling quantization in accordance with the received number of quantization bits. It is beneficial for the remote radio unit to receive the number of quantization bits from a baseband unit as it provides a channel for feedback for the determinations made in the baseband unit. The baseband unit observers the quality and changes the number of bits if the quality is observed too low.

In an embodiment the method further comprises receiving quantized signals from at least two remote radio units, wherein each of received signals comprises a separated signal origination from one user equipment and combining signals received from at least two of remote radio units belonging to the same user equipment. It is beneficial to allow use of a plurality of remote radio units to communicate with a single user equipment. The received signals can then be combined in the baseband unit in order to form a complete signal belonging to a user equipment. Combining already separated signals is efficient.

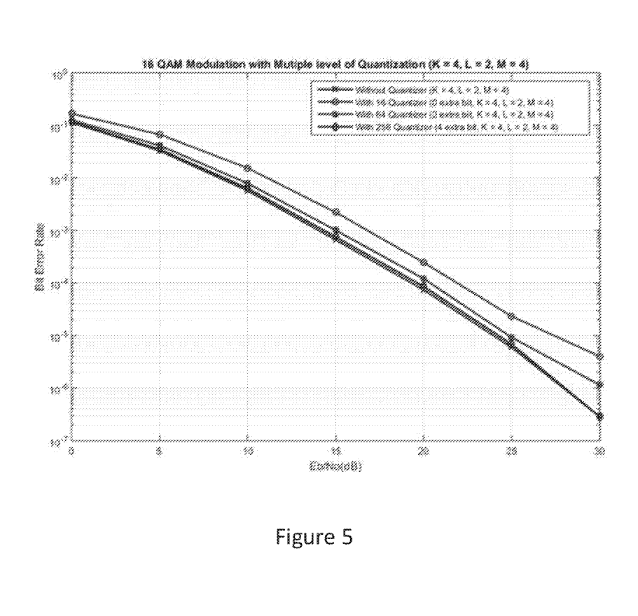

FIG. 5 illustrates simulation results of a system having at least one network device and a baseband unit as disclosed above. FIG. 5 shows the BER performance for a scenario with 4 user antennas, 2 network devices, each being equipped with 4 antennas (K=4, L=2 and M=4). The BER performance with different levels of quantization are compared: it can be observed that there is a trade-off between the loss (compared with no quantization) and the number of extra bits. With 4 extra quantization bits, the loss is negligible. It is possible to use 0 extra bits, but the loss is around 3 dB (at BER 10-5). The diversity order with this scenario is given by (M−K+1)×L=2.

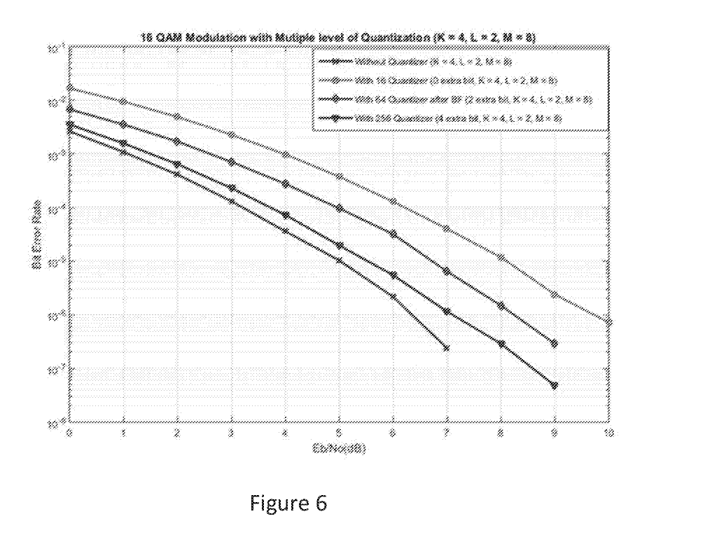

FIG. 6 shows the BER performance for a scenario with 4 user antennas, and 2 network devices, each being equipped with 8 antennas (K=4, L=2 and M=8). With 4 extra bits, the BER performance has a loss around 0.5 dB. With 0 extra bits, the loss reaches around 3 dB. The diversity order here is 10.

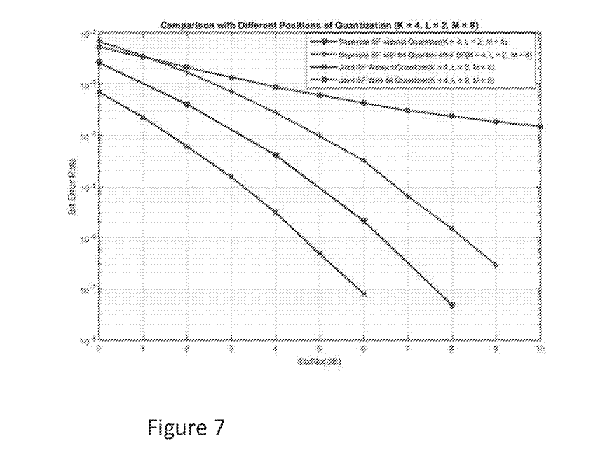

FIG. 7 compares the performance of the arrangement described above with conventional C-RAN. The brown curve shows the performance with the conventional C-RAN quantization, quantization before FFT. It can be observed that the curve has a high error floor, such that the BER no longer improves with increasing Eb/N0. The black curve show the performance of the arrangements described above, it can be seen that the error floor has been removed. The red curve shows the conventional method without quantization (or equivalently with infinite precision quantization). In this case the signals from all antennas at all network devices are combined at the BBU using MRC, which achieves a higher diversity order: M×L−K+1=13. This gives better performance than the methods described above without quantization, which is shown in the blue curve. Of course the unquantized (infinite precision) case is not practical as it would require an effectively infinite fronthaul load.

The system and method for wireless communication network synchronization has been described in conjunction with various embodiments herein. However, other variations to the disclosed embodiments can be understood and effected by those skilled in the art in practicing the claimed network element, baseband unit, system and method, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems.

1. A network device for wireless communication comprising:
a first transceiver configured to receive a signal from an at least one user equipment;
a processor configured to:
separate signals belonging to each user equipment from the received signal; and
quantize said separated signals; and
a second transceiver configured to transmit said quantized signals.

2. The network device of claim 1, wherein said processor is further configured to receive a determined number of quantization bits and control quantization of said separated signals in accordance with said determined number of quantization bits based on at least one of the following: an access link quality between user equipment and said network device; and a data transfer rate between said network device and a baseband unit.

3. The network device of claim 1, wherein the network device further comprises a beamformer configured to separate N signals received by M antennas into K user equipment signals from the received signal by said first transceiver.

4. The network device of claim 1, wherein said processor is further configured to separate sub-channels of said received signal by said first transceiver before separating signals belonging to each user equipment.

5. The network device of claim 1, wherein said network device further comprises a channel estimator configured to estimate channel properties between said at least one user equipment and said network device before said processor separates signals belonging to each user equipment.

6. A baseband unit for baseband processing comprising:
a transceiver configured to receive signals from one or more network device, wherein each of received signals comprises a quantized separated signal belonging to each user equipment; and
a processor configured to combine signals received from at least two network devices and belonging to same user equipment.

7. A Baseband unit of claim 6, wherein said transceiver is configured to determine the number of quantization bits and transmit the determined number of quantization bits to one or more network devices.

8. A Baseband unit of claim 6, wherein said processor is further configured to receive the number of quantization bits from an external device and transmit the determined number of quantization bits to one or more network devices.

9. A system comprising:
a plurality of network devices, wherein each of network devices further comprise:
a first transceiver configured to communicate with a number of user equipment;
a processor configured to:
separate signals belonging to a different user equipment from a received signal by said first transceiver; and;
quantize said separated signals; and
a second transceiver configured to transmit said quantized signals;
a baseband unit further comprises:
a transceiver configured to: receive signals from one or more network device, wherein each of received signals comprises a quantized separated signal belonging to each user equipment;
a processor configured to combine signals received from at least two network devices and belonging to same user equipment; and
a network connection configured to transfer data between said plurality of network devices and said baseband unit.

10. The system of claim 9, wherein said transceiver of said baseband unit is further configured to determine the number of quantization bits and transmit the determined number of quantization bits to one or more network devices;
wherein said processor of said baseband unit is further configured to receive the number of quantization bits from an external device and transmit the determined number of quantization bits to one or more network devices.

11. A method for transmitting data from a network device to a baseband unit comprising:
receiving a radio signal from an at least one user equipment;
separating signals belonging to each user equipment from said received radio signal;
quantizing said separated signals; and
transmitting said quantized signals to a baseband unit.

12. The method of claim 11, wherein said method further comprises:
collecting information of at least one of the following: an access link quality between said at least one user equipment and network devices; and data transfer rate between said network devices and said baseband unit;
determining at said baseband unit the required number of quantization bits based on said collected information, and
transmitting said determined number of quantization bits to at least one network device.

13. The method of claim 11, wherein separating signals belonging to each user equipment using beamforming.

14. The method of claim 13, wherein said separating further comprises estimating coefficients for beamforming.

15. The method of claim 11, wherein the method further comprises receiving at said network device the number of quantization bits and controlling quantization in accordance with said received number of quantization bits.

16. The method of claim 11, wherein the method further comprises:
receiving quantized signals from at least two network devices, wherein each of received quantized signals comprises a quantized separated signal origination from one user equipment; and
combining signals received from at least two of network devices belonging to the same user equipment.

17. The method of claim 11, wherein the method further comprises:
separating sub-channels of said received radio signal and separating signals belonging to each user equipment from said separated sub-channels.

18. A computer program product, comprising:
a non-transitory computer-readable medium storing computer executable instructions, wherein the instructions comprises:
instructions for receiving a radio signal from an at least one user equipment;
instructions for separating signals belonging to each user equipment from said received radio signal;
instructions for quantizing said separated signals; and
instructions for transmitting said quantized signals to a baseband unit.
